(19) United States
(12) Patent Application Publication
(10) Pub. No.: US 2018/0173460 A1
(43) Pub. Date: Jun. 21, 2018

(54) CONTENTION REDUCTION SCHEDULER FOR NAND FLASH ARRAY WITH RAID

(71) Applicant: Western Digital Technologies, Inc., Irvine, CA (US)

(72) Inventors: Zvonimir Z. BANDIC, San Jose, CA (US); Minghai QIN, San Jose, CA (US); Chao SUN, San Jose, CA (US); Dejan VUCINIC, San Jose, CA (US)

(73) Assignee: Western Digital Technologies, Inc.

(21) Appl. No.: 15/380,430

(22) Filed: Dec. 15, 2016

(51) Int. Cl. G06F 3/06

(52) U.S. Cl. CPC G06F 3/0659; G06F 3/0688; G06F 3/0604

(57) ABSTRACT

The present disclosure generally relates to a flash storage system, and more particularly to a scheduler in the flash storage system. The flash storage system includes a device queue, a scheduler coupled to the device queue, and a plurality of dies. In one embodiment, the scheduler pushes commands from the device queue into one or more dies of the plurality of dies for processing in read command phase and write command phase. By separately pushing read commands and write commands into dies for processing, latency is decreased and TOPS is increased.

### BACKGROUND OF THE DISCLOSURE

### Field of the Disclosure

Embodiments of the present disclosure generally relate a flash storage system, and more particularly to a scheduler in the flash storage system.

### Description of the Related Art

Flash storage systems, such as flash memory based solid-state drive (SSD) devices, have become the preferred technology for many applications in recent years. The ability to store large amounts of data and to withstand harsh operating environment, together with the non-volatile nature of the storage, makes these flash storage devices appealing for many applications.

A common practice with flash memory is to operate multiple memory dies in parallel to increase write performance. Each die has parallelism of one, so read and write commands have to be queued if the commands are targeted at the same die. Queued read or write command has to wait for the predecessor command in the targeted die to finish before being processed. A write command has a much longer latency than a read command. For example, a write command has a latency of about 1000 microseconds while a read command has a latency of about 80 microseconds. This asymmetry in latency causes latency issues for read commands, which typically is more important for most applications. In addition, technologies such as redundant array of independent disks (RAID) or chipkill requires writing a stripe (row) of dies when processed, so the write unit is a row of dies while the read unit is a single die. The difference in latency between read commands and write commands along with the requirement of writing a stripe of dies increase latency and decrease input/output operations per second (TOPS).

Therefore, an improved flash storage system is needed.

### SUMMARY OF THE DISCLOSURE

The present disclosure generally relates to a flash storage system, and more particularly to a scheduler in the flash storage system. The flash storage system includes a device queue, a scheduler coupled to the device queue, and a plurality of dies. In one embodiment, the scheduler pushes commands from the device queue into one or more dies of the plurality of dies for processing in read command phase and write command phase. By separately pushing read commands and write commands into dies for processing, latency is decreased and TOPS is increased.

In one embodiment, a method comprises receiving a plurality of read commands and a plurality of write commands by a device queue, pushing one or more read commands of the plurality of read commands into one or more targeted dies of a plurality of dies by a scheduler, stopping pushing read commands of the plurality of read commands into the plurality of dies when a predetermined number of write commands of the plurality of write commands in the device queue have been accumulated, processing the one or more read commands in the one or more targeted dies so the plurality of dies are available for processing, and pushing the predetermined number of write commands of the plurality of write commands in the device queue into the plurality of dies for processing by the scheduler.

In another embodiment, an electronic device comprises a processor and a memory device. The memory device comprises a device queue, a plurality of dies, and a scheduler coupled to the device queue and the plurality of dies. The electronic device further comprises a memory system storing instructions that, when executed by the processor, cause the electronic device to: receive a plurality of read commands and a plurality of write commands by the device queue, push one or more read commands of the plurality of read commands into one or more targeted dies of the plurality of dies by the scheduler, stop pushing read commands of the plurality of read commands into the plurality of dies when a predetermined number of write commands of the plurality of write commands in the device queue have been accumulated, process the one or more read commands in the one or more targeted dies so the plurality of dies are available for processing, and push the predetermined number of write commands of the plurality of write commands in the device queue into the plurality of dies for processing by the scheduler.

In another embodiment, a non-transitory computer readable storage medium, containing instructions that, when executed by a processor, cause a memory device to perform read and write processes, by performing the steps of: receiving a plurality of read commands and a plurality of write commands by the device queue, pushing one or more read commands of the plurality of read commands into one or more targeted dies of the plurality of dies by the scheduler, stopping pushing read commands of the plurality of read commands into the plurality of dies when a predetermined number of write commands of the plurality of write commands in the device queue have been accumulated, processing the one or more read commands in the one or more targeted dies so the plurality of dies are available for processing, and pushing the predetermined number of write commands of the plurality of write commands in the device queue into the plurality of dies for processing by the scheduler.

In another embodiment, a method comprises receiving a plurality of read commands and a plurality of write commands by a device queue, receiving availability information of a plurality of dies by a scheduler, and pushing commands of the plurality of read commands and the plurality of write commands into dies of the plurality of dies based on a priority of the commands, if the dies are available.

In another embodiment, an electronic device comprises a processor and a memory device. The memory device comprises a device queue, a plurality of dies, and a scheduler coupled to the device queue and the plurality of dies. The electronic device further comprises a memory system storing instructions that, when executed by the processor, cause the electronic device to: receive a plurality of read commands and a plurality of write commands by a device queue, receive availability information of a plurality of dies by a scheduler, and push commands of the plurality of read commands and the plurality of write commands into dies of the plurality of dies based on a priority of the commands, if the dies are available.

In another embodiment, a non-transitory computer readable storage medium, containing instructions that, when executed by a processor, cause a memory device to perform read and write processes, by performing the steps of: receiving a plurality of read commands and a plurality of write commands by a device queue, receiving availability information of a plurality of dies by a scheduler, and pushing commands of the plurality of read commands and the plurality of write commands into dies of the plurality of dies based on a priority of the commands, if the dies are available.

In another embodiment, an electronic device comprises a processor and a memory device. The memory device comprises means for receiving a plurality of read commands and a plurality of write commands, means for pushing one or more read commands of the plurality of read commands into one or more targeted dies of the plurality of dies, means for stopping pushing read commands of the plurality of read commands into the plurality of dies when a predetermined number of write commands of the plurality of write commands in the device queue have been accumulated, means for processing the one or more read commands in the one or more targeted dies so the plurality of dies are available for processing, and means for pushing the predetermined number of write commands of the plurality of write commands in the device queue into the plurality of dies for processing.

In another embodiment, an electronic device comprises a processor and a memory device. The memory device comprises means for receiving a plurality of read commands and a plurality of write commands, means for receiving availability information of a plurality of dies, and means for pushing commands of the plurality of read commands and the plurality of write commands into dies of the plurality of dies based on a priority of the commands, if the dies are available.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an example electronic system including a flash memory device according to one embodiment described herein.

FIG. 2 illustrates an electronic system used to access a flash memory device according to one embodiment described herein.

FIG. 3 is a flow diagram of a method for pushing commands into a plurality of dies using a scheduler according to one embodiment described herein.

FIG. 4 is a flow diagram of a method for pushing commands into the plurality of dies using the scheduler according to another embodiment described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to a flash storage system, and more particularly to a scheduler in the flash storage system. The flash storage system includes a device queue, a scheduler coupled to the device queue, and a plurality of dies. In one embodiment, the scheduler pushes commands from the device queue into one or more dies of the plurality of dies for processing in read command phase and write command phase. By separately pushing read commands and write commands into dies for processing, latency is decreased and TOPS is increased.

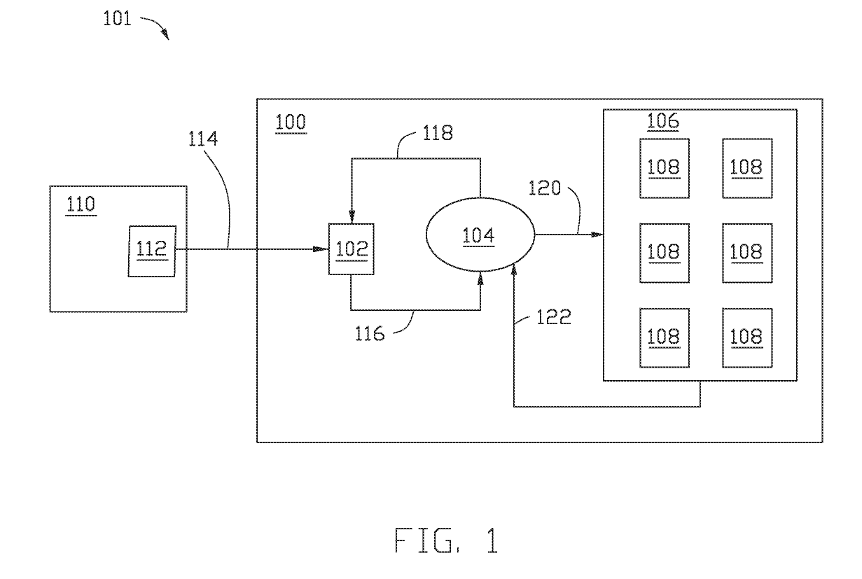

FIG. 1 illustrates an electronic system 101 according to one embodiment described herein. The electronic system 101 includes a flash memory device 100 and a host 110 coupled to the flash memory device 100. The host 110 may be any computing or electronic device, such as a computer workstation, an embedded computing system, a network router, a laptop computer, a personal digital assistant, a digital camera, a cellular phone, or a tablet. The flash memory device 100 may be any flash memory based device, such as a flash memory based SSD, a flash memory card, or a flash storage array. The flash memory device 100 includes a device queue 102, a scheduler 104 coupled to the device queue 102, and a flash memory 106 coupled to the scheduler 104. The flash memory 106 includes a plurality of dies 108. In one embodiment, the plurality of dies 108 include 256 dies arranged in 16 rows with each row having 16 dies. Each die of the plurality of dies 108 has a parallelism of one, so commands have to be queued if the commands are targeted at the same die. Queued command has to wait for the predecessor command in the targeted die to finish before being processed. In addition, the flash memory 106 may employ RAID technology, requiring writing a stripe (row) of dies when processed, so the write unit is a row of dies while the read unit is a single die.

The host 110 includes a host queue 112 for receiving read and write commands from a user of the host 110. The commands in the host queue 112 are pushed to the device queue 102 by a connection 114 in a first-in-first-out (FIFO) manner. The number of commands can be stored in the device queue 102 is referred to as queue depth. The queue depth of the device queue 102 may be 256, 1024 or any suitable number of commands.

The device queue 102 may be a priority queue, which means the longer a command in the device queue 102, the higher the priority. Conventionally, commands in a device queue are pushed into one or more dies based on the priority. Read commands are targeted to specific dies and write commands are randomly assigned to a row of dies. If one or more dies in the assigned row of dies are not available, the write command has to wait for the one or more dies in the assigned row to be available before being processed by the row of dies. In addition, since the row of dies assigned for the write command is randomly assigned, read commands targeted to the specific dies in the row of dies have to wait for the write command to finish. The difference in latency between read commands (about 80 microseconds) and write commands (about 1000 microseconds) along with the requirement of writing a row of dies increase latency and decrease TOPS.

In order to decrease latency and increase TOPS, the scheduler 104 is utilized. The scheduler 104 can receive commands from the device queue 102 by a connection 116 and push commands into one or more dies 108 by a connection 120. In addition, the scheduler 104 can scan the device queue 102 by a connection 118 and receive availability information of the plurality of dies 108 by a connection 122.

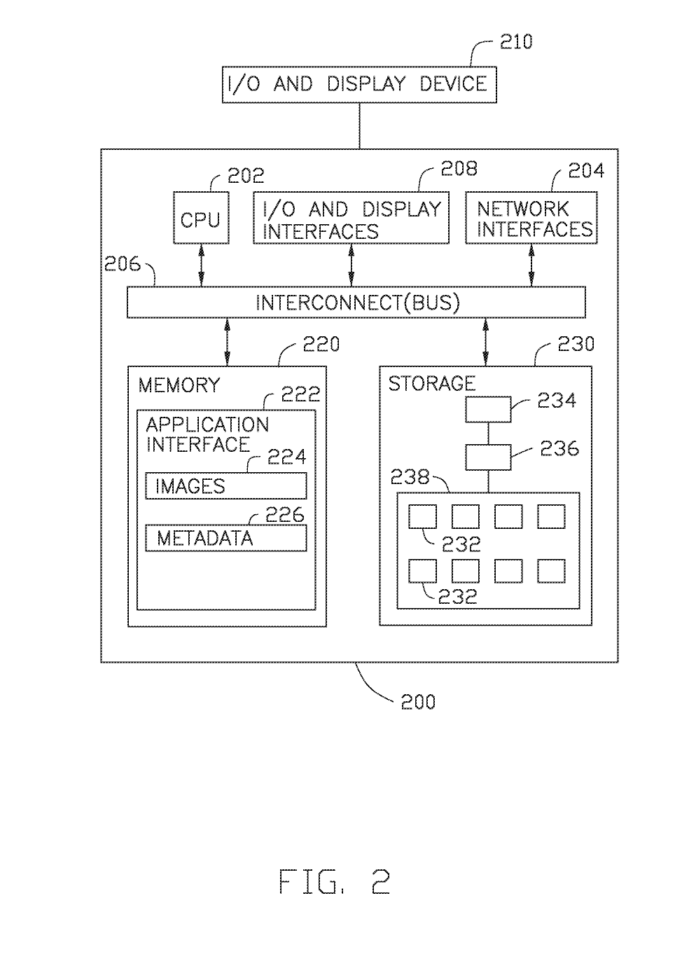

FIG. 2 illustrates an electronic system 200, such as the electronic system 101, according to one embodiment described herein. The electronic system 200 may be a computer that may include, without limitation, a central processing unit (CPU) 202, a network interface 204, an interconnect 206, a memory 220, and additional storage 230 such as a flash memory device. The electronic system 200 may also include an I/O device interface 208 connecting I/O devices 210 (for example, keyboard, display, touchscreen, and mouse devices) to the electronic system 200.

CPU 202 is included to be representative of a single CPU, multiple CPU's, a single CPU having multiple processing cores, etc., and the memory 220 is generally included to be representative of a random access memory. The interconnect 206 may be used to transmit programming instructions and application data between the CPU 202, I/O device interfaces 208, storage 230, network interface 204, and memory 220. Storage 230, such as a flash memory based SSD, may store non-volatile data. The storage 230 may contain a device queue 234, a scheduler 236 coupled to the device queue 234, and a flash memory 238 coupled to the scheduler 236. The flash memory 238 includes a plurality of dies 232. The storage 230 may be the flash memory device 100, the device queue 234 may be the device queue 102, the scheduler 236 may be the scheduler 104, the flash memory 238 may be the flash memory 106, and the plurality of dies 232 may be the plurality of dies 108 shown in FIG. 1. Illustratively, the memory 220 may include an application interface 222, which itself may display images 224, and/or store metadata 226 of images 224.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present example also relates to an apparatus for performing the operations herein. This apparatus may be specially constructed for the illustrated purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system interconnect.

The structure for a variety of these systems will appear from the description above. In addition, the present examples are not described with reference to any particular programming language, and various examples may thus be implemented using a variety of programming languages.

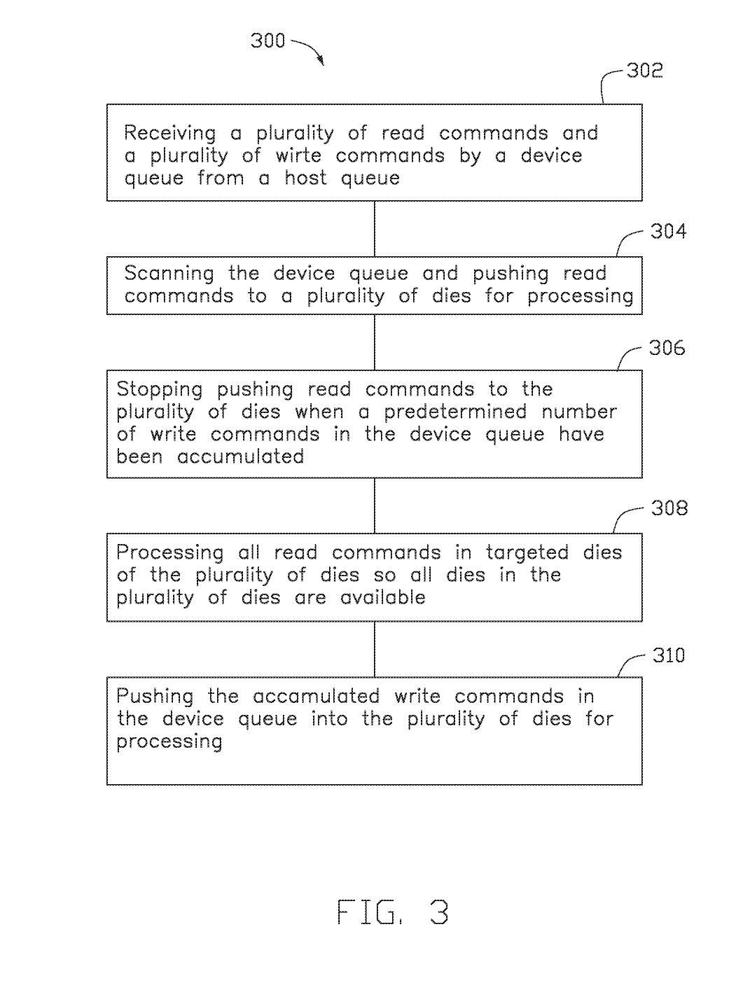

FIG. 3 is a flow diagram of a method 300 for pushing commands into a plurality of dies using a scheduler according to one embodiment described herein. The plurality of dies may be the plurality of dies 108, and the scheduler may be the scheduler 104 as shown in FIG. 1. The method 300 starts at block 302, which is receiving a plurality of read commands and write commands by a device queue from a host queue. The device queue may be the device queue 102, and the host queue may be the host queue 112 as shown in FIG. 1. In one embodiment, a host, such as the host 110, is generating 70 percent read commands and 30 percent write commands at a constant host submission rate and pushing the read and write commands into the host queue.

Next, at block 304, the scheduler scans the device queue and pushes read commands into a plurality of dies for processing. The scheduler scans the device queue and prioritizes the plurality of read commands and write commands from high to low, and the priority is based on how long a command is in the device queue. The longer the command is in the device queue, the higher the priority. The commands are pushed into the plurality of dies in a read phase by the scheduler, which means read commands are pushed into corresponding dies of the plurality of dies while write commands in the device queue are not being pushed into the plurality of dies.

For example, the device queue has a queue depth of 256, and the top 10 commands having priority from high to low are: write, write, read, read, read, write, read, read, read, and read. Conventionally, the two write commands having the highest priority are pushed into two random rows of dies of the plurality of dies for processing. If the next three or more read commands are targeted to the dies in the two rows of dies that are processing the write commands, the next three or more read commands need to wait for the write commands to finish before being pushed into the targeted dies. With the scheduler operating in the read phase, the write commands are skipped in the device queue (i.e., not pushed into the dies for processing) and the read commands are pushed into targeted dies of the plurality of dies for processing. In some embodiments, the scheduler is capable of receiving availability information of the plurality of dies, and read commands are pushed into the targeted dies if the targeted dies are available.

Next, at block 306, the scheduler stops pushing read commands from the device queue into the plurality of dies when a predetermined number of write commands in the device queue have been accumulated. The number of accumulated write commands in the device queue equals to the number of write commands that have been skipped in the device queue. In other words, the accumulated write commands in the device queue may have higher priority than one or more read commands that have been pushed into the plurality of dies for processing. The predetermined number of accumulated write commands may equal to the number of rows of dies in the plurality of dies, i.e., the ratio of the number of rows of dies in the plurality of dies to the predetermined number of accumulated write commands is one. For example, in one embodiment, the plurality of dies includes 16 rows of dies, and the predetermined number of accumulated write commands in the device queue is 16. The predetermined number of accumulated write commands may be a fixed ratio of the number of rows of dies. Fixed ratio means that the ratio of the number of rows of dies in the plurality of dies to the predetermined number is fixed such as one, 1.5, two, 2.5 etc., as long as the predetermined number is an integer. In one embodiment, the predetermined number of accumulated write commands equals to 50 percent of the number of rows of dies in the plurality of dies due to peak power constraints. In this case, the ratio of the number of rows of dies in the plurality of dies to the predetermined number is two. Thus, in the example that the number of rows of dies is 16, the predetermined number of accumulated write commands in the device queue is eight. In another embodiment, the predetermined number of accumulated write commands equals to 25 percent of the number of rows of dies, and the ratio of the number of rows of dies in the plurality of dies to the predetermined number is four. Thus, in the example that the number of rows of dies is 16, the predetermined number of accumulated write commands in the device queue is four. In another embodiment, the predetermined number of accumulated write commands equals to 62.5 percent of the number of rows of dies, and the ratio of the number of rows of dies in the plurality of dies to the predetermined number is 1.6. Thus, in the example that the number of rows of dies is 16, the predetermined number of accumulated write commands in the device queue is 10. The number of rows of dies in the plurality of dies may be any suitable number, such as 16 or 32, and the predetermined number of accumulated write commands in the device queue is based on a fixed ratio of the number of rows of dies in the plurality of dies. When the predetermined number of accumulated write commands in the device queue is reached, the scheduler stops pushing read commands into the plurality of dies from the device queue.

Next, at block 308, all read commands in the targeted dies of the plurality of dies are processed so all dies of the plurality of dies are available for processing. The scheduler pushes the accumulated write commands in the device queue into the plurality of dies for processing, as shown at block 310. The scheduler is operating in a write phase, which means write commands are pushed into the plurality of dies while read commands in the device queue are not being pushed into the plurality of dies. After all the write commands in the plurality of dies are processed, the scheduler operates in the read phase again, i.e., the scheduler performs the operation shown at block 304. The operations shown at blocks 302, 304, 306, 308, 310 may be repeated. The operations shown at blocks 302, 304, 306, 308, 310 may be controlled by a host, such as the host 110 shown in FIG. 1, or by a CPU, such as the CPU 202 shown in FIG. 2. The method 300 shows an interleaved read and write operation, in which the scheduler alternately operates in read phase and write phase. By separating read commands and write commands, latency is decreased and TOPS is increased.

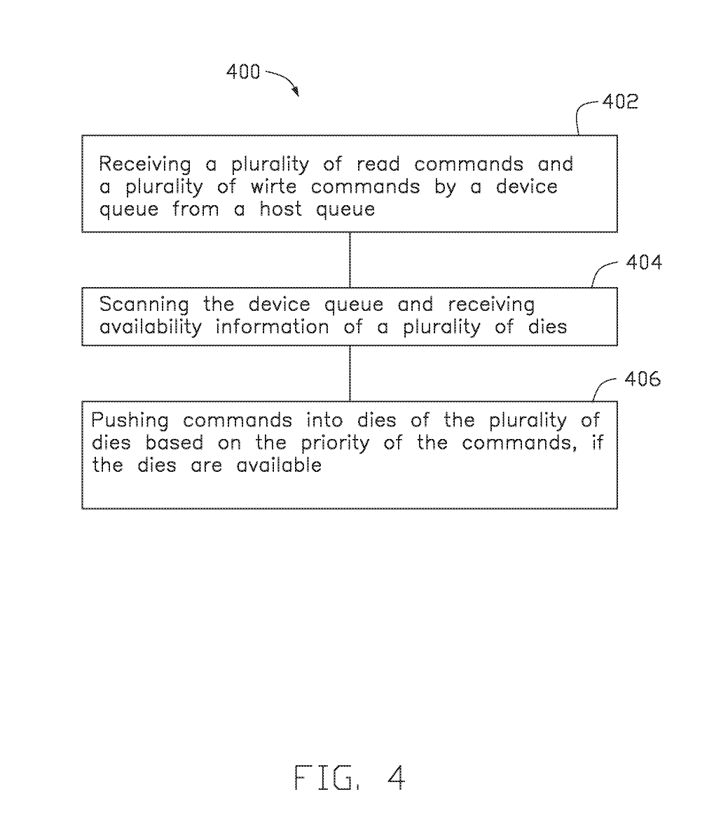

FIG. 4 is a flow diagram of a method 400 for pushing commands into the plurality of dies using the scheduler according to another embodiment described herein. The plurality of dies may be the plurality of dies 108, and the scheduler may be the scheduler 104 as shown in FIG. 1. The method 400 starts at block 402, which is receiving a plurality of read commands and write commands by a device queue from a host queue. The device queue may be the device queue 102, and the host queue may be the host queue 112 as shown in FIG. 1. In one embodiment, a host, such as the host 110, is generating 70 percent read commands and 30 percent write commands at a constant host submission rate and pushing the read and write commands into the host queue.

Next, at block 404, the scheduler scans the device queue with priority from high to low, and the priority is based on how long a command is in the device queue. The longer the command is in the device queue, the higher the priority. The scheduler also receives availability information of the plurality of dies. The commands in the device queue, regardless of read or write, are pushed into dies of the plurality of dies by the scheduler based on the priority of the commands, if the dies are available, as shown at block 306. The operations shown at blocks 402, 404, 406 may be repeated. The operations shown at blocks 402, 404, 406 may be controlled by a host, such as the host 110 shown in FIG. 1, or by a CPU, such as the CPU 202 shown in FIG. 2.

For example, the device queue has a queue depth of 256, and the top 10 commands having priority from high to low are: read, read, write, read, read, write, read, read, write, and read. Conventionally, the two read commands having the highest priority are pushed into targeted dies of the plurality of dies for processing. The next command based on the priority is a write command which is pushed into a row of dies that is randomly chosen. If the row of dies includes at least one of the targeted dies that are processing the read command, the write command has to wait for the read command to finish before being processed. With the scheduler that is capable of receiving availability information of the plurality of dies, the scheduler can search for an available row of dies in the plurality of dies, and the write command is pushed into the available row of dies. The potential waiting time for a prior command to finish processing in a die is reduced or eliminated when the scheduler can receive availability information of the plurality of dies. In this “greedy write” operation, the write commands are not pushed into a randomly chosen row of dies that may include one or more dies that are processing a command. Instead, the scheduler searches for a row of dies that is available for processing, and pushes the write command into the available row of dies for processing. By having a scheduler that can receive availability information of the plurality of dies and search for available rows for write commands, latency is decreased and IOPS is increased.

Multiple simulations were run to show the benefits of having the scheduler that can perform either the interleaved read and write operation or the “greedy write” operation. The simulations were set up so all read commands were uniformly distributed over a NAND array having 16 rows of dies with each row having 16 dies, write commands did not have targeted dies and each write command took up a row of dies, a host was generating 70 percent of read commands and 30 percent of write commands at a constant host submission rate and pushing the commands into a host queue, and a scheduler had access to device queue and to available information of all dies. The simulations were run with following parameters: read latency was 80 microseconds, write latency was 1000 microseconds, garbage collection was not considered, and three different queue depths (64, 256 and 1024) were tested.

The simulations were run to compare the interleaved read and write operation and the “greedy write” operation to a base operation. The base operation was set up so the scheduler scanned the device queue with priority from high to low and pushed commands into the plurality of dies in FIFO manner. For write commands, the scheduler randomly assigned a row of dies without knowing whether all dies in the row of dies were available for processing. With a queue depth of 256, the base operation showed an IOPS of about 450K commands per second, and the interleaved read and write operation showed an IOPS of about 600 K commands per second, which is a 33 percent improvement. With a queue depth of 1024, the base operation showed an IOPS of about 575K commands per second, and the interleaved read and write operation showed an IOPS of about 700 K commands per second, which is a 22 percent improvement. The theoretical TOPS limit for the simulations was about 719K commands per second, so the interleaved read and write operation is near the maximum IOPS.

The various latencies, such as average, 99 percent, 99.9 percent, and 99.99 percent, were also improved with the interleaved read and write operation and the “greedy write” operation compared to the base operation. With a queue depth of 64, a power limit of 0.25, and a 200K commands per second submission rate from the host queue to the device queue, the base operation showed an average latency of about 210 microseconds, a 99 percent latency of about 1425 microseconds, a 99.9 percent latency of about 2060 microseconds, and a 99.99 percent latency of about 3025 microseconds. The interleaved read and write operation showed an average latency of about 196 microseconds, a 99 percent latency of about 1050 microseconds, a 99.9 percent latency of about 1115 microseconds, and a 99.99 percent latency of about 1140 microseconds. The “greedy write” operation showed an average latency of about 193 microseconds, a 99 percent latency of about 1030 microseconds, a 99.9 percent latency of about 1065 microseconds, and a 99.99 percent latency of about 1105 microseconds. With a queue depth of 256 without a power limit, and a 375K commands per second submission rate from the host queue to the device queue, the base operation showed an average read latency of about 443 microseconds, a 99 percent read latency of about 2800 microseconds, a 99.9 percent read latency of about 4440 microseconds, and a 99.99 percent read latency of about 6800 microseconds. The interleaved read and write operation showed an average read latency of about 346 microseconds, a 99 percent read latency of about 1120 microseconds, a 99.9 percent read latency of about 1160 microseconds, and a 99.99 percent read latency of about 1200 microseconds. The base operation showed an average write latency of about 1952 microseconds, a 99 percent write latency of about 6000 microseconds, a 99.9 percent write latency of about 8880 microseconds, and a 99.99 percent write latency of about 12800 microseconds. The interleaved read and write operation showed an average write latency of about 2089 microseconds, a 99 percent write latency of about 3200 microseconds, a 99.9 percent write latency of about 3400 microseconds, and a 99.99 percent write latency of about 3480 microseconds.

With a queue depth of 256 without a power limit, and a 450K commands per second submission rate from the host queue to the device queue, the base operation showed an average read latency of about 1280 microseconds, a 99 percent read latency of about 5200 microseconds, a 99.9 percent read latency of about 7920 microseconds, and a 99.99 percent read latency of about 10800 microseconds. The interleaved read and write operation showed an average read latency of about 447 microseconds, a 99 percent read latency of about 1160 microseconds, a 99.9 percent read latency of about 1240 microseconds, and a 99.99 percent read latency of about 1280 microseconds. The base operation showed an average write latency of about 3452 microseconds, a 99 percent write latency of about 9720 microseconds, a 99.9 percent write latency of about 13560 microseconds, and a 99.99 percent write latency of about 16480 microseconds. The interleaved read and write operation showed an average write latency of about 1671 microseconds, a 99 percent write latency of about 2280 microseconds, a 99.9 percent write latency of about 2440 microseconds, and a 99.99 percent write latency of about 2640 microseconds.

With a queue depth of 1024 without a power limit, and a 575K commands per second submission rate from the host queue to the device queue, the base operation showed an average read latency of about 2309 microseconds, a 99 percent read latency of about 11680 microseconds, a 99.9 percent read latency of about 17520 microseconds, and a 99.99 percent read latency of about 21600 microseconds. The interleaved read and write operation (with the predetermined number of accumulated write commands in the device queue equaled to 16) showed an average read latency of about 1358 microseconds, a 99 percent read latency of about 3840 microseconds, a 99.9 percent read latency of about 5240 microseconds, and a 99.99 percent read latency of about 6560 microseconds. The interleaved read and write operation (with the predetermined number of accumulated write commands in the device queue equaled to 8) showed an average read latency of about 919 microseconds, a 99 percent read latency of about 3120 microseconds, a 99.9 percent read latency of about 3800 microseconds, and a 99.99 percent read latency of about 4160 microseconds. The base operation showed an average write latency of about 6817 microseconds, a 99 percent write latency of about 20800 microseconds, a 99.9 percent write latency of about 28160 microseconds, and a 99.99 percent write latency of about 31120 microseconds. The interleaved read and write operation (with the predetermined number of accumulated write commands in the device queue equaled to 16) showed an average write latency of about 1231 microseconds, a 99 percent write latency of about 1640 microseconds, a 99.9 percent write latency of about 1760 microseconds, and a 99.99 percent write latency of about 2520 microseconds. The interleaved read and write operation (with the predetermined number of accumulated write commands in the device queue equaled to 8) showed an average write latency of about 2151 microseconds, a 99 percent write latency of about 4120 microseconds, a 99.9 percent write latency of about 4240 microseconds, and a 99.99 percent write latency of about 4840 microseconds.

By utilizing a scheduler that is configured to perform an interleaved read and write operation, which means the scheduler is alternately operating in a read phase and a write phase, latency is decreased and IOPS is increased. Alternatively, the scheduler is capable of receiving availability information of a plurality of dies and search for available row of dies for processing. Waiting time for prior command to finish processing is reduced or eliminated, which also lead to decreased latency and increased IOPS.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
receiving a plurality of read commands and a plurality of write commands by a device queue;
pushing one or more read commands of the plurality of read commands into one or more targeted dies of a plurality of dies by a scheduler;
stopping pushing read commands of the plurality of read commands into the plurality of dies when a predetermined number of write commands of the plurality of write commands in the device queue have been accumulated;
processing the one or more read commands in the one or more targeted dies so the plurality of dies are available for processing; and
pushing the predetermined number of write commands of the plurality of write commands in the device queue into the plurality of dies for processing by the scheduler.

2. The method of claim 1, wherein the device queue has a queue depth of 64, 256, or 1024.

3. The method of claim 1, further comprising scanning the device queue by the scheduler prior to pushing one or more read commands of the plurality of read commands into one or more targeted dies.

4. The method of claim 3, wherein the scheduler prioritizes the plurality of read commands and the plurality of write commands as the scheduler scans the device queue.

5. An electronic device, comprising:
a processor;
a memory device, comprising:
a device queue;
a plurality of dies; and
a scheduler coupled to the device queue and the plurality of dies; and
a memory system storing instructions that, when executed by the processor, cause the electronic device to:
receive a plurality of read commands and a plurality of write commands by the device queue;
push one or more read commands of the plurality of read commands into one or more targeted dies of the plurality of dies by the scheduler;
stop pushing read commands of the plurality of read commands into the plurality of dies when a predetermined number of write commands of the plurality of write commands in the device queue have been accumulated;
process the one or more read commands in the one or more targeted dies so the plurality of dies are available for processing; and
push the predetermined number of write commands of the plurality of write commands in the device queue into the plurality of dies for processing by the scheduler.

6. The electronic device of claim 5, wherein the device queue has a queue depth of 64, 256, or 1024.

7. The electronic device of claim 5, further comprising scanning the device queue by the scheduler prior to pushing one or more read commands of the plurality of read commands into one or more targeted dies.

8. The electronic device of claim 7, wherein the scheduler prioritizes the plurality of read commands and the plurality of write commands as the scheduler scans the device queue.

9. A non-transitory computer readable storage medium, containing instructions that, when executed by a processor, cause a memory device to perform read and write processes, by performing the steps of:
receiving a plurality of read commands and a plurality of write commands by a device queue;
pushing one or more read commands of the plurality of read commands into one or more targeted dies of a plurality of dies by a scheduler;
stopping pushing read commands of the plurality of read commands into the plurality of dies when a predetermined number of write commands of the plurality of write commands in the device queue have been accumulated;
processing the one or more read commands in the one or more targeted dies so the plurality of dies are available for processing; and
pushing the predetermined number of write commands of the plurality of write commands in the device queue into the plurality of dies for processing by the scheduler.

10. The storage medium of claim 9, wherein the device queue has a queue depth of 64, 256, or 1024.

11. The storage medium of claim 9, further comprising scanning the device queue by the scheduler prior to pushing one or more read commands of the plurality of read commands into one or more targeted dies.

12. The storage medium of claim 11, wherein the scheduler prioritizes the plurality of read commands and the plurality of write commands as the scheduler scans the device queue.

13. A method, comprising:
receiving a plurality of read commands and a plurality of write commands by a device queue;
receiving availability information of a plurality of dies by a scheduler; and
pushing commands of the plurality of read commands and the plurality of write commands into dies of the plurality of dies based on a priority of the commands, if the dies are available.

14. The method of claim 13, wherein the device queue has a queue depth of 64, 256, or 1024.

15. The method of claim 13, further comprising scanning the device queue and prioritizing the plurality of read commands and the plurality of write commands the by the scheduler.

16. The method of claim 13, wherein the priority of the commands are based on how long the commands are in the device queue.

17. An electronic device, comprising:
a processor;
a memory device, comprising:
a device queue;
a plurality of dies; and
a scheduler coupled to the device queue and the plurality of dies; and
a memory system storing instructions that, when executed by the processor, cause the electronic device to:
receive a plurality of read commands and a plurality of write commands by the device queue;
receive availability information of the plurality of dies by the scheduler; and
push commands of the plurality of read commands and the plurality of write commands into dies of the plurality of dies based on a priority of the commands, if the dies are available.

18. The electronic device of claim 17, wherein the device queue has a queue depth of 64, 256, or 1024.

19. The electronic device of claim 17, further comprising scanning the device queue and prioritizing the plurality of read commands and the plurality of write commands the by the scheduler.

20. The electronic device of claim 17, wherein the priority of the commands are based on how long the commands are in the device queue.

21. A non-transitory computer readable storage medium, containing instructions that, when executed by a processor, cause a memory device to perform read and write processes, by performing the steps of:
receiving a plurality of read commands and a plurality of write commands by a device queue;
receiving availability information of a plurality of dies by a scheduler; and
pushing commands of the plurality of read commands and the plurality of write commands into dies of the plurality of dies based on a priority of the commands, if the dies are available.

22. The electronic device of claim 21, wherein the device queue has a queue depth of 64, 256, or 1024.

23. The electronic device of claim 21, further comprising scanning the device queue and prioritizing the plurality of read commands and the plurality of write commands the by the scheduler.

24. The electronic device of claim 21, wherein the priority of the commands are based on how long the commands are in the device queue.

25. An electronic device, comprising:
a processor; and
a memory device, comprising:
means for receiving a plurality of read commands and a plurality of write commands;
means for pushing one or more read commands of the plurality of read commands into one or more targeted dies of the plurality of dies;
means for stopping pushing read commands of the plurality of read commands into the plurality of dies when a predetermined number of write commands of the plurality of write commands in the device queue have been accumulated;
means for processing the one or more read commands in the one or more targeted dies so the plurality of dies are available for processing; and
means for pushing the predetermined number of write commands of the plurality of write commands in the device queue into the plurality of dies for processing.

26. The electronic device of claim 25, wherein the means for receiving a plurality of read commands and a plurality of write commands is a device queue.

27. The electronic device of claim 25, wherein the means for pushing one or more read commands of the plurality of read commands into one or more targeted dies of the plurality of dies is a scheduler.

28. The electronic device of claim 25, wherein the means for pushing the predetermined number of write commands of the plurality of write commands in the device queue into the plurality of dies for processing is a scheduler.

29. An electronic device, comprising:
a processor; and
a memory device, comprising:
means for receiving a plurality of read commands and a plurality of write commands;
means for receiving availability information of a plurality of dies; and
means for pushing commands of the plurality of read commands and the plurality of write commands into dies of the plurality of dies based on a priority of the commands, if the dies are available.

30. The electronic device of claim 29, wherein the means for receiving a plurality of read commands and a plurality of write commands is a device queue.

31. The electronic device of claim 29, wherein the means for receiving availability information of a plurality of dies is a scheduler.

32. The electronic device of claim 29, wherein the means for pushing commands of the plurality of read commands and the plurality of write commands into dies of the plurality of dies based on a priority of the commands, if the dies are available, is a scheduler.
